(19) United States
(12) Patent Application Publication
(10) Pub. No.: US 2012/0175918 A1
(43) Pub. Date: Jul. 12, 2012

(54) FOLDING TABLE AND CHAIR SET WITH PORTABLE CARRYING CASE

(75) Inventors: Scott Southwick, Farmington, UT (US); E. Vince Rhoton, Layton, UT (US); Joel Bennett, Clinton, UT (US); Brandon Smith, South Ogden, UT (US); Mitch Johnson, South Weber, UT (US); David C. Winter, Layton, UT (US); Wendell Peery, Kaysville, UT (US)

(73) Assignee: LIFETIME PRODUCTS, INC., Clearfield, UT (US)

(21) Appl. No.: 13/346,535

(22) Filed: Jan. 9, 2012

Related U.S. Application Data
(60) Provisional application No. 61/431,432, filed on Jan. 10, 2011.

(51) Int. Cl. A47B 3/14; B23P 11/00; B29C 49/00

(52) U.S. Cl. 297/135; 264/500; 29/428

(57) ABSTRACT

A table and chair set may include a table, a plurality of chairs and a storage case. The table may include a folding table top that has a footprint in the folded position. The chairs may be folding chairs that have a footprint generally equal to or slightly smaller than the footprint of the table in the folded position. The case may include an interior cavity that is sized and configured to receive at least a portion of the table and the chair in the folded positions, the cavity having a size generally equal to or slightly larger than the footprint of the folding table and the folding chair in the folded positions.

### CROSS-REFERENCE TO RELATED APPLICATIONS

The present application claims priority to and the benefit of U.S. Provisional Patent Application Ser. No. 61/431,432, entitled FOLDING TABLE AND CHAIR SET WITH PORTABLE CARRYING CASE, which was filed on Jan. 10, 2011, and is hereby incorporated by reference in its entirety.

### BACKGROUND OF THE INVENTION

1. Field of the Invention

The present invention is generally directed towards furniture, such as tables and chairs. The tables and chairs may be part of a set and a carrying case may be used to transport and/or store the tables and chairs.

2. Description of Related Art

Many types of tables are well known and used for a variety of purposes. For example, conventional tables may include a table top and legs that are attached to the table top. Known tables may also include folding legs that are pivotally attached to the table top. The folding legs may be movable between a use position in which the legs extend outwardly from the table top and a storage position in which the legs are folded against an underneath surface of the table top. Tables with large, rectangular table tops and folding legs are often referred to as “banquet tables” and these tables are often used in places such as assembly halls, banquet halls, convention centers, hotels, schools, churches, and other locations where large groups of people meet. Tables with smaller, square table tops and folding legs are often referred to as “card tables.” Because banquet and card tables include folding legs, the tables are relatively portable and can be moved or stored when no longer needed. The folding legs allow the tables to be stored in smaller areas than tables without folding legs.

The ability to move the folding legs into a collapsed position allows the table to be more conveniently stored. Even when the legs are collapsed, however, the table top of many conventional tables still retains its original size and shape. For instance, conventional card tables often have sides measuring about three feet in length. As a result, the storage of card tables even with the legs in the collapsed position still requires a relatively large area.

When a table is used, it is frequently desired to allow people to sit at the table to allow one or more persons to eat, work, or undertake other activities. Therefore, chairs are frequently used in connection with tables. Conventional chairs typically include four legs, a chair seat and a chair back. When the chairs are not in use and desired to be stored, some known chairs may be stacked one on top of the other. The vertically stacked chairs have the same or slightly larger footprint that a single chair. Thus, for example, if the chairs have a length and width between about eighteen inches to about twenty four inches, then the stacked chairs will still require about the same amount of floor space as one of the chairs. Moreover, as more and more chairs are stacked, the stack can become prone to leaning or tipping. In order to prevent the stacked chairs from falling over, the number of chairs that may be stacked may be limited and multiple stacks of chairs may be required, which may necessitate the use of additional space.

To alleviate some of the challenges associated with stackable chairs, conventional folding chairs may be used. Known folding chairs are typically lightweight, portable chairs that fold relatively flat and can be stored in a stack or row. Folding chairs are generally used for seating in areas where permanent seating is not possible or practical. This may include outdoor and indoor events such as funerals, college graduations, religious services, sporting events and various types of competitions. Folding chairs may also be used in the home when additional seating is required such as for parties, card games, and other social events. Many folding chairs include a pivot point proximate a rear portion of the seat and the seat is generally aligned with the backrest and back supports when the chair is in the folded position.

When a folding chair is disposed in the folded position, it has a depth that is much less than in the unfolded position. For instance, in the use position, a conventional folding chair may be about eighteen inches wide, about eighteen inches deep, and about thirty-five inches high. In the collapsed or folded position, the depth of the chair may be much smaller, such as between four or five inches, while generally maintaining the same width and height of the chair. Consequently, a single folding chair may be stored in an area that is much smaller than a comparable non-folding chair. It is known that multiple folding chairs may be aligned or stacked in the folded position. Disadvantageously, the stacked or aligned chairs are often not very stable and have a tendency to fall over. In addition, the chairs may require a large amount of space even in the folded position.

Furthermore, transporting conventional tables and chairs can be problematic. For example, banquet tables are often difficult to move because of their large size and weight. This may make it challenging to move by a single person and two or more people may be required. Banquet tables may also be precluded from being transported in the trunk or back seat of a car or automobile because of its large size. Therefore, a truck, trailer or other large sized vehicle may be necessary to move the tables, especially if multiple tables are being transported. Similarly, while a single chair may be movable by a single person, often times multiple chairs are required and it is difficult for a single person to carry or move more than one chair in a single trip. In addition, when a single person attempts to carry two or more chairs, the chairs may be difficult to grip and may be easily dropped, especially if going up or down stairs, around corners, or traveling long distances. Consequently, multiple people and/or multiple trips are often required to move convention tables and chairs.

### BRIEF SUMMARY OF THE INVENTION

A need therefore exists for tables and chairs that eliminate the above-described disadvantages and problems.

One aspect is a table and chair set that may be sized and configured to be used together. Advantageously, the tables and chairs may be used in combination or as part of a group or collection. For instance, the table and chair set may include a table and four chairs. In addition, a carrying case may be used in connection with the table and chairs. Significantly, the table, chairs and carrying case may provide a useful, efficient and convenient way to transport and/or store the table and chairs.

Another aspect is a table that may include a table top and one or more legs or support structures. The legs are preferably movable between an extended or use position and a folded or collapsed position relative to the table top. The table may be a fold-in-half table in which the table top may be moved between folded and unfolded positions. For example, in the unfolded position, the table top may include two sections that are generally disposed in the same plane with an upper surface of the first section generally aligned with an upper surface of the second section. In the folded position, the first and second sections of the table top may be positioned generally adjacent to each other such that one section is disposed on top of the other section.

Still another aspect is a chair that may include legs, seat and backrest. The chair is preferably a folding chair that is movable between a use or unfolded position and a collapsed or folded position. When the chair is in the folded position, the legs may be generally aligned in a parallel configuration and the seat may be generally aligned with the backrest.

Yet another aspect is a container that may be sized and configured to receive at least a portion of one or more folding tables and chairs. In particular, the container, which may form at least a portion of a portable carrying and/or storage case, may be sized and configured to receive one or more tables and chairs in the folded position. Advantageously, the container may form part of the table and chair set. For example, the set may include a fold-in-half table and four folding chairs, and the container may be sized and configured to receive the table and chairs in the folded position. The container may include an outer shell and an interior portion that is sized to receive the table and chairs in the folded position. Significantly, the container may not only assist in transporting and/or storing the table and chairs, the container may also help protect the table and chairs from damage.

A further aspect is a table and chair set that may include a folding table that is selectively movable between folded and unfolded configurations. The table and chair set may also include one or more folding chairs that are selectively movable between folded and unfolded configurations. The table and chair set may be sized and configured to be disposed in a container or case, preferably when the table and chairs are in the folded positions.

A still further aspect is a table and chair set that may include at least one folding table and at least one folding chair. If desired, the table and chair set may include a folding table, four folding chairs and a container with an interior portion or cavity that is sized and configured to receive the table and chairs. Advantageously, the cavity may correspond to the size of the table and chairs in a folded and stacked configuration. In particular, the table and chairs may be disposed in the folded positions and the folded table and chairs may be stacked in an aligned configuration. Desirably, an outer perimeter of the folding table and chairs may also be aligned in the stacked configuration. The stacked, folded table and chairs may be disposed within the cavity of the container such that the table and chairs are generally aligned in parallel planes, adjacent tables and chairs contact or abut, and the table and chairs are sandwiched together within the container. Advantageously, this may allow the table and chairs to be efficiently and orderly transported and/or stored.

Yet another further aspect is a method for storing a table and chair set within a case or container. For instance, the container may include an opening, which may be selectively covered by a lid, and a receiving portion. A plurality of chairs, preferably in a folded configuration, may be inserted into the opening and at least partially or substantially placed within the receiving portion. Additionally, a table, preferably also in the folded configuration, may be inserted into the opening and at least partially or substantially placed within the receiving portion. This may allow the table and chairs to be quickly and efficiently stored within the container.

Another aspect is a table and chair set that may include a container or storage case. For example, the set may include a table with a square table top that folds in half with each portion of the table top having generally the same length and width. The set may also include four substantially identical folding chairs. When the chairs and table are in the folded position, the chairs and table preferably have generally the same width and length, or footprint. In particular, the folding chairs can have a footprint in the folded configuration that is generally equal to or less than the size of the footprint of the table in the folded configuration. Significantly, if the table and chairs have generally the same footprint in the folded positions, that may facilitate stacking and/or alignment of the table and chairs. This may also allow the outer perimeter of the chairs and tables to be generally aligned when the folded table and chairs are stacked. Advantageously, if the folded table and chairs have generally the same footprint, the aligned table and chairs may be easily and efficiently disposed within the container. The container may have an interior cavity slightly larger than the folded table and chairs to snugly receive the table and chairs, which may minimize the required storage area. In addition, the storage case may include hard or rigid sides, which may help position and/or align the tables and/or chairs within the case. Further, the case may facilitate shipping and/or storage of the table and chairs, and may help protect the table and chairs from damage during shipping and/or storage, especially if the case has hard sides.

Still another aspect is case or container for a table and chair set that may be constructed from blow-molded plastic. For example, the entire outer shell or body of the container may be constructed as part of a unitary, one-piece structure during the blow-molding process. In this embodiment, the case may include an outer wall constructed from a single layer of plastic and the interior portion, which is sized and configured to receive the folded table and chairs, may be disposed within the outer wall. Thus, a single outer wall may form the sides of the container and the hollow interior portion may be defined by the outer wall. Advantageously, this may allow the container to be formed as part of a single, one-piece blow-molded plastic structure. The container may be cut along all or a portion of its length and/or width to create an opening to allow the table and chairs to be inserted and removed from the hollow interior portion.

Yet another aspect is a container for a table and chair set that may include one or more structures integrally formed as part of the container during the blow-molding process. For example, the case may include a wheel receiving portion that is sized and configured to allow one or more wheels to be attached. Desirably, the wheel receiving portion allows an axle and at least one wheel to be attached to facilitate moving the case. The case may also include a handle receiving portion that may allow a handle to be attached. The handle may be moved between an outwardly extending or use position that facilitates moving and/or carrying the case and a storage position. Advantageously, at least a portion of the handle may be disposed in the handle receiving portion when the handle is in the storage position. In addition, the case may include a gripping structure, such as a protrusion, edge and/or recessed portion, to facilitate moving and/or carrying the case. If desired, the gripping structure may be integrally formed with the case as part of a unitary, one-piece construction. Further, the case may include one or more attachment portions that allow the case to be secured in the closed position. If desired, all or a portion of the wheel receiving portion, handle receiving portion, gripping portion and/or attachment portions may be integrally formed with the case as part of a unitary, one-piece structure.

A further aspect is a case for a table and chair set that may be latched or secured in the closed position. For instance, one or more connectors may be used to secure the case in the closed position. In greater detail, one or more cords, lines or straps may be used to secure the case in the closed position. Preferably, the cords, lines or straps are stretchable or elastic to allow the case to be quickly and easily secured in the closed position. For example, one or more lines may be connected to one portion of the case and the line may be connected or looped around another portion of the case to help maintain the case in the closed position. In particular, a first line may be connected to a first portion of the case and it may be disposed about an engaging and/or receiving portion of a second portion of the case. Additionally, a second line may be connected to the first portion of the case and it may be disposed about an engaging and/or receiving portion of the second portion of the case. The lines are preferably elastic so that a user can stretch the line around the engaging portion and/or place the line in the receiving portion.

A still further aspect is a table and chair set that may be used with a dual purpose case. For example, the case may assist in moving and transporting the table and chairs. In particular, the case may facilitate shipping by the manufacturer and transporting by the retailer and consumer. In addition, the case may facilitate storage of the table and chairs. Significantly, the case may allow the table and chairs to be stored in a single location and/or as part of a group or set. The case may also keep the table and chairs together and/or prevent the table and chairs from being inadvertently separated. The case may also provide a compact, space-saving way to move and store the table and chairs. Further, the case may be lightweight and multiple cases may be stacked, which may facilitate shipping, storing and displaying by the manufacturer, retailer and/or consumer.

These and other aspects, features and advantages of the present invention will become more fully apparent from the following brief description of the drawings, the drawings, the detailed description of preferred embodiments and appended claims.

### BRIEF DESCRIPTION OF THE DRAWINGS

The appended drawings contain figures of preferred embodiments to further illustrate and clarify the above and other aspects, advantages and features of the present invention. It will be appreciated that these drawings depict only preferred embodiments of the invention and are not intended to limits its scope. Additionally, it will be appreciated that while the drawings may illustrate preferred sizes, scales, relationships and configurations of the invention, the drawings are not intended to limit the scope of the claimed invention. The invention will be described and explained with additional specificity and detail through the use of the accompanying drawings in which:

FIG. 1 is a perspective view of an exemplary embodiment of a table and chair set, illustrating the table and chairs in an unfolded or use position;

FIG. 2 is a perspective view of the table and chair set, illustrating the table and chairs in a folded or collapsed position;

FIG. 3 is a perspective view of the table and chair set, illustrating the table and chairs in an exemplary folded and stacked or aligned configuration;

FIG. 4 is a perspective view of the table and chair set with an exemplary embodiment of a case, illustrating an exemplary configuration and arrangement of the table, chairs and case;

FIG. 5 is a perspective view of the table and chairs disposed within the case, illustrating the case in an open configuration;

FIG. 6 is an upper perspective view of the case, illustrating the case in a closed configuration;

FIG. 7 is another upper perspective view of the case, illustrating a handle in an extended or use position and the case in the closed configuration; and

FIG. 8 is a lower perspective view of the case, illustrating the handle in the extended or use position and the case in the closed configuration.

### DETAILED DESCRIPTION OF THE PREFERRED EMBODIMENTS

The present invention is directed towards a table and chair set. The principles of the present invention, however, are not limited to a table and chair set. It will be understood that, in light of the present disclosure, the tables and chairs disclosed herein can be successfully used independently and/or in combination with other types of furniture and structures.

Additionally, to assist in the description of the table and chair set, words such as top, bottom, front, rear, right and left are used to describe the accompanying figures. Further, the drawings may be to scale and may indicate preferred shapes, sizes, configurations and/or arrangements of the table and chair set, and various aspects, features, parts and components of the table and chair set. The drawings, however, are not necessarily to scale and the table and chair set may have other suitable shapes, sizes, configurations, arrangements, aspects, features, parts and components. It will be appreciated that the table and chair set can be located in a variety of desired positions, including various angles, sideways and even upside down. A detailed description of the table and chair set now follows.

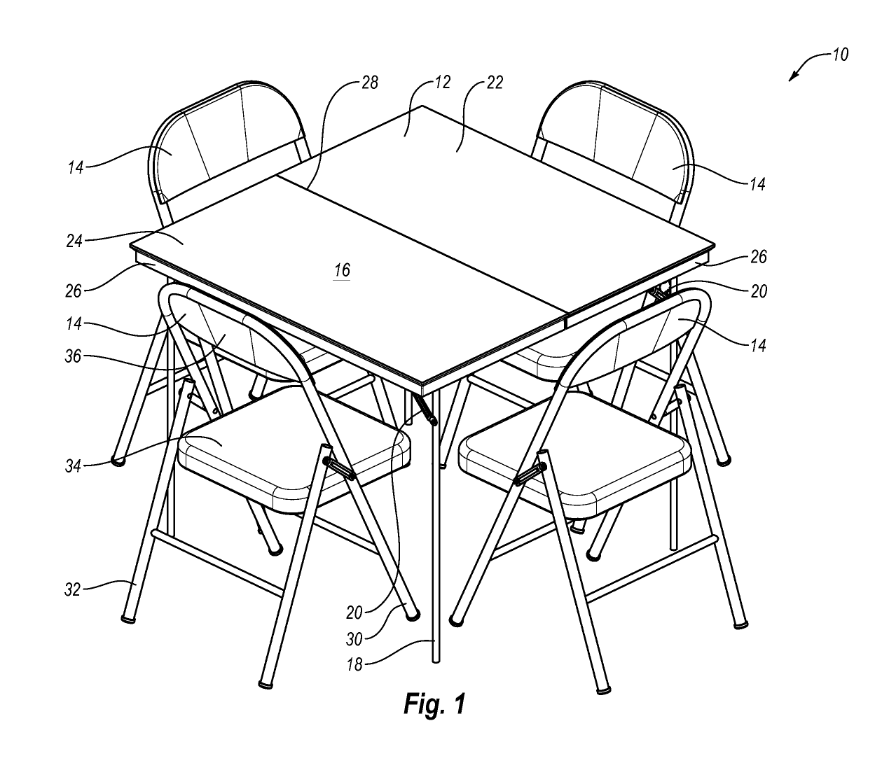

As shown in FIG. 1, the table and chair set 10 may include a table 12 and one or more chairs 14. The table 12 may be a card table with a square table top 16 and legs 18. The legs 18 may be movable between extended and collapsed positions relative to the table top 16. As indicated in the accompanying figures, the legs 18 may be independently attached and individually movable relative to the table top 16. In addition, a brace 20 may assist in attaching the legs 18 relative to the table top 16 and/or help control movement of the legs between the extended and collapsed positions.

The table 12 may be a fold-in-half table in which the table top 16 includes a first section 22 and a second section 24. The first and second sections 22, 24 of the table top 16 are preferably movable relative to each other to create the fold-in-half table. For example, the first and second sections 22, 24 of the table top 16 may be pivotally connected. In addition, the table 12 may include a frame 26 that is connected to the first and second sections 22, 24 of the table top 16. The frame 26 may facilitate connection of the legs 18 to the table top 16 and/or connection of the first and second sections 22, 24 of the table top. The first and second sections 22, 24 of the table top 16 preferably have generally the same size, shape and configuration. In particular, the first and second sections 22, 24 of the table top 16 preferably have the same width and length. Additionally, when the table top 16 is in the folded position, the first and second sections 22, 24 of the table top 16 are preferably disposed adjacent to each other and generally aligned. Thus, the first and second sections 22, 24 of the table top 16 preferably have generally matching shapes and sizes. Further, in the folded position, the first and second sections 22, 24 of the table top 16 are preferably vertically aligned with an outer perimeter of one section aligned with the outer perimeter of the other section.

As shown in FIG. 1, the table and chair set 10 may include one table 12 and four chairs 14. It will be understood that the table and chair set 10 may include any suitable number of tables and chairs. It will also be understood that the table 12 and chair 14 may have various suitable shapes, sizes, configurations and arrangements. For example, the table 12 preferably has a square table top 16 with sides measuring between about two and about four feet in length, although such lengths may be larger or smaller in other embodiments. For example, the table top 16 may have a length and a width of about three feet or thirty-six inches in the unfolded position, and the first and section sections 22, 24 of the table top may have a length of about thirty-six inches and a width of about eighteen inches in the folded position. The table top 16 may also have other shapes and sizes, such as a rectangular or circular configuration, with sides or diameters measuring between about two feet and about twelve feet in length. The table 12 may have one or more various features, aspects, components, shapes, sizes and configurations, such as shown in U.S. Pat. Nos. 6,945,178; 6,431,092; 7,707,947; 7,299,754; 7,096,799; 7,299,753; 7,461,601; 7,703,402; 7,975,625; and 8,042,476; which are incorporated by reference in their entireties.

The table 12 and chairs 14 shown in FIG. 1 are in the unfolded or use positions. In this configuration, the table 12 can be used to support one or more items such as games, food, or other objects. The first and second sections 22, 24 of the table top 16 may be separated by a fold line 28. In this embodiment, the fold line 28 extends in a single direction and is approximately centered between the opposing sections 22, 24 of the table top 16. Thus, the fold line 28 may separate the table top 16 into two sections that are of approximately equal size. For instance, if the table top 16 has sides of about three feet in length, the fold line 28 may separate the table top into first and second sections 22, 24 measuring about three feet in length by about one and a half feet in width.

In greater detail, the fold line 28 represents a line along which the table top 16 can be folded. For instance, the first section 22 of the table top 16 can be rotated relative to the second section 24 of the table top. In particular, the first section 22 may be rotated about one hundred eighty degrees such that the undersides of the first and second sections 22, 24 are disposed at least adjacent and/or contact or engage each other. If desired, the first and second sections 22, 24 may be connected by one or more hinges. Although the first and second sections 22, 24 may be rotated relative to each other in the manner described, the table top 16 may be disposed in the collapsed position in any suitable manner. For example, the first and second sections 22, 24 of the table top 16 may be moved such that the upper surfaces of the table top are disposed at least adjacent and/or contact or engage each other in the closed position.

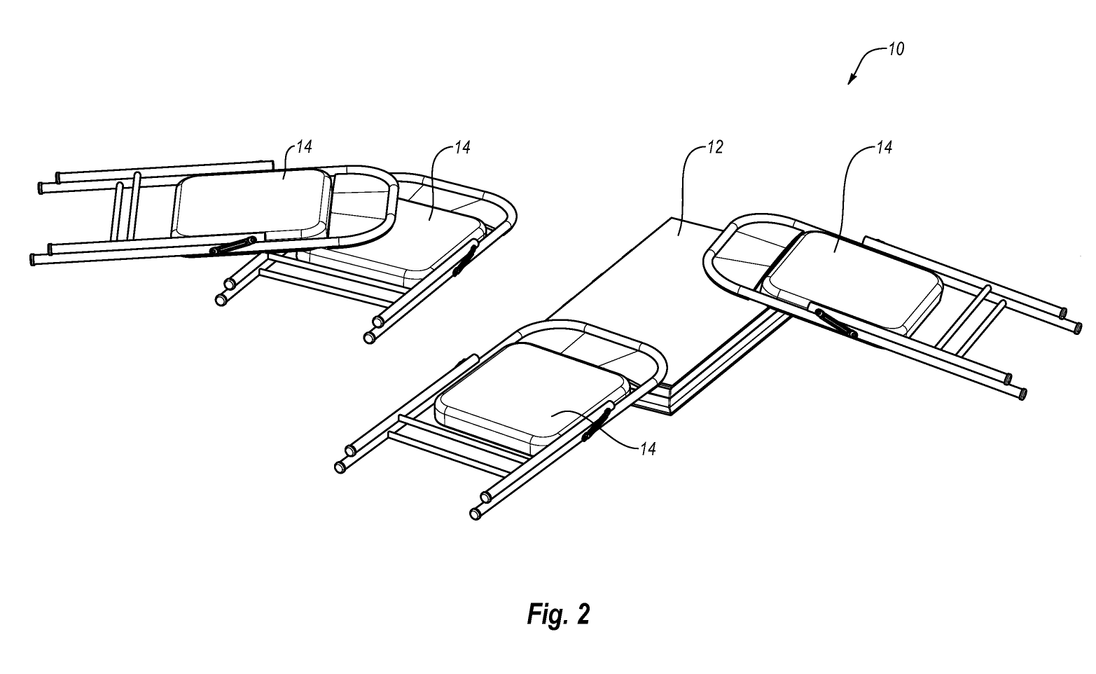

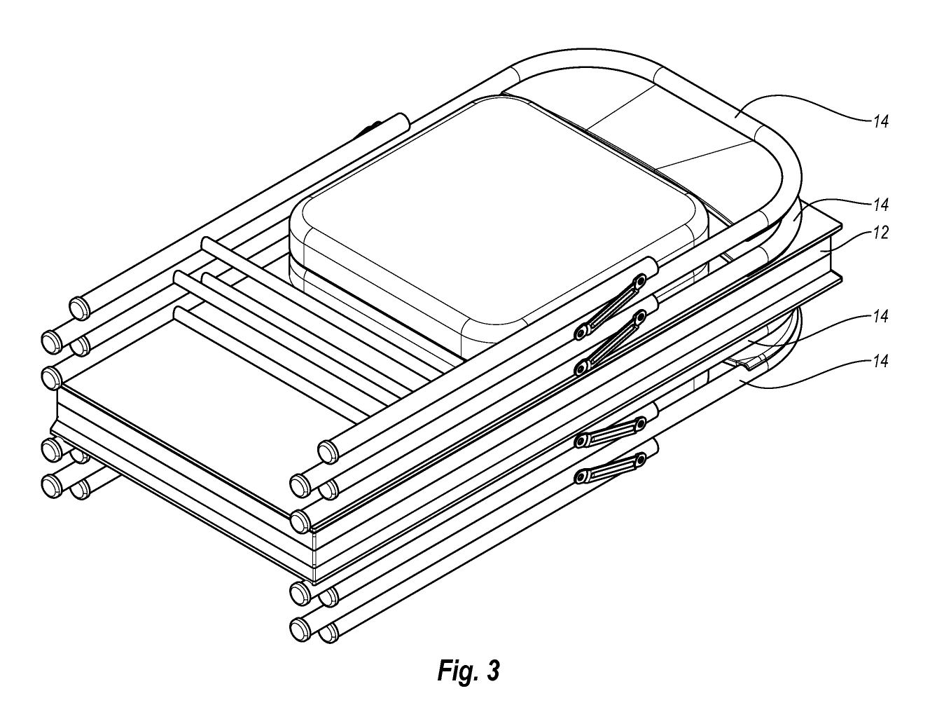

As shown in FIG. 1, the folding chairs 14 are disposed in a seating position. The chairs 14 may include front legs 30 and rear legs 32, a seat 34, and a backrest 36. The front and rear legs 30, 32 may be movable relative to each other to place the chair 14 into a folded or collapsed configuration such as illustrated in FIGS. 2 and 3. The chairs 14 may have one or more various features, aspects, components, shapes, sizes and configurations, such as shown in U.S. Pat. Nos. 6,543,842; 7,017,986; and 7,452,035; which are incorporated by reference in their entireties.

FIG. 2 illustrates an exemplary embodiment of the table and chair set 10 including the table 12 and four chairs 14. As shown in FIG. 2, the table 12 and chairs 14 are in the folded, collapsed or storage configuration. Advantageously, the folded or collapsed configuration may facilitate storage of the table 12 and chairs 14. In addition, the folded or collapsed configuration may assist and enable stacking or otherwise arranging the table 12 and/or chairs 14 for storage.

For example, as shown in FIG. 3, the folded table 12 and chairs 14 may be disposed in a stacked or aligned configuration. In this exemplary embodiment, two chairs 14 are placed in the folded configuration, arranged in a similar orientation, and stacked one on top of the other. The table 12 may then be placed on the two stacked chairs 14. The two more chairs 14 may then be stacked in a manner similar to the other chairs and placed on top of the table 12. While the table 12 and the chairs 14 are arranged into a single vertical stack, it will be appreciated the table and chairs may be disposed in other arrangements and configurations such as vertical, horizontal, angled and the like.

The stacking of the table 12 and chairs 14 shown in FIG. 3 is merely illustrative. For instance, in another embodiment, the table 12 may be positioned at a lowermost position and the chairs 14 may be placed on the table. Alternatively, the table 12 may be placed on a stack of the chairs 14. Further, other arrangements and orientations of the table and/or chairs may also be possible. For example, the table and chair set 10 may include more or fewer chairs 14 and/or tables 12, in which case the arrangement may be altered. In addition, the tables 12 and/or chairs 14 may have different shapes, sizes, configurations and arrangements, which may allow the table and chairs to be stacked in different configurations and arrangements. As an example, the table 12 may be a banquet table with a rectangular table top, which may be folded into one or more sections, and one or more chairs may be stacked on one or both sides of the table. Further, the table 12 and chairs 14 may be stacked or aligned in different arrangements or configurations. For example, one or more chairs 14 may be disposed in a first direction and other chairs may be disposed in a second direction.

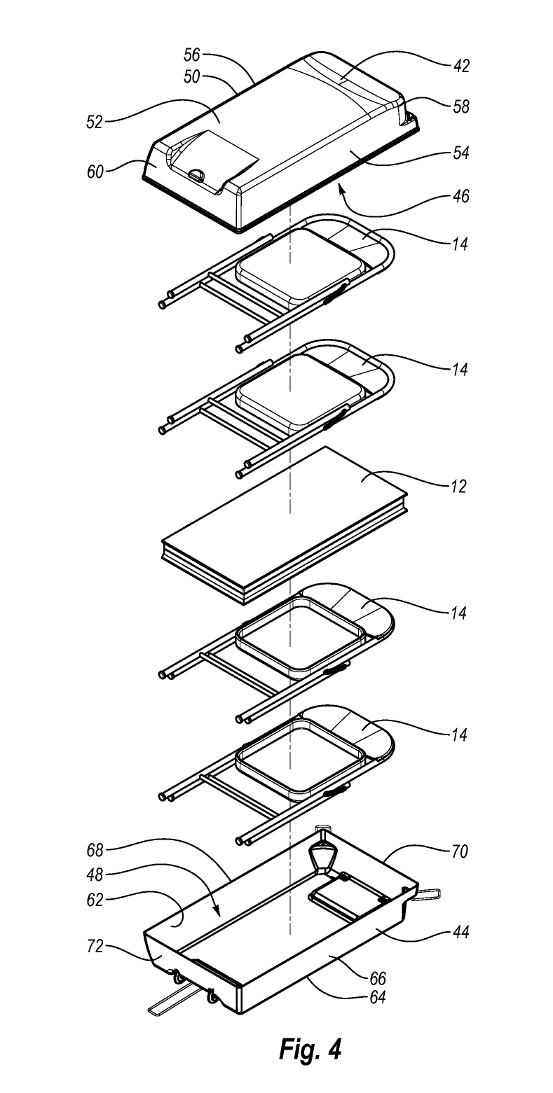

As shown in FIGS. 4-8, a container or case 40 may be used in connection with the table 12 and chairs 14. Thus, the table and chair set 10 may include a table 12, four chairs 14 and a case 40 to form a six piece set. The case 40 may allow the table 12 and/or chairs 14 to be selectively enclosed or otherwise at least partially disposed within the container. As shown in FIG. 4, the case 40 may include a first or upper portion 42 and a second or lower portion 44. The first and second portions 42, 44 are preferably movable relative to each other and may be removable relative to each other. In addition, the first and second portions 42, 44 may be generally similar in size. For instance, the first and second portions 42, 44 may each form two halves of the case 40, although this is merely exemplary.

By way of illustration, as best seen in FIG. 4, the first portion 42 of the case 40 may include an interior portion or opening 46 and the second portion 44 of the container may include an interior portion or opening 48. The first and second interior portions 46, 48 are preferably sized and configured to receive the table 12 and chairs 14. For example, at least a portion of the folded, stacked table 12 and chairs 14 may be disposed in the interior portion 46 of the first portion 42 of the case 40. In addition, at least a portion of the folded, stacked table 12 and chairs 14 may be disposed in the interior portion 48 of the second portion 44 of the container.

In greater detail, the first portion 42 of the case 40 may include an outer wall 50 that forms at least a portion of a surface 52, a first side wall 54, a second side wall 56, a first end wall 58 and a second end wall 60. The interior portion 46 is preferably disposed within an area at least partially defined by the surface 52, the side walls 54, 56, and the end walls 58, 60. The second portion 44 of the case 40 may have a similar configuration with an outer wall 62 that forms at least a portion of a surface 64, a first side wall 66, a second side wall 68, a first end wall 70 and a second end wall 72. The interior portion 48 is preferably disposed within an area at least partially defined by the surface 64, the side walls 66, 68, and the end walls 70, 72.

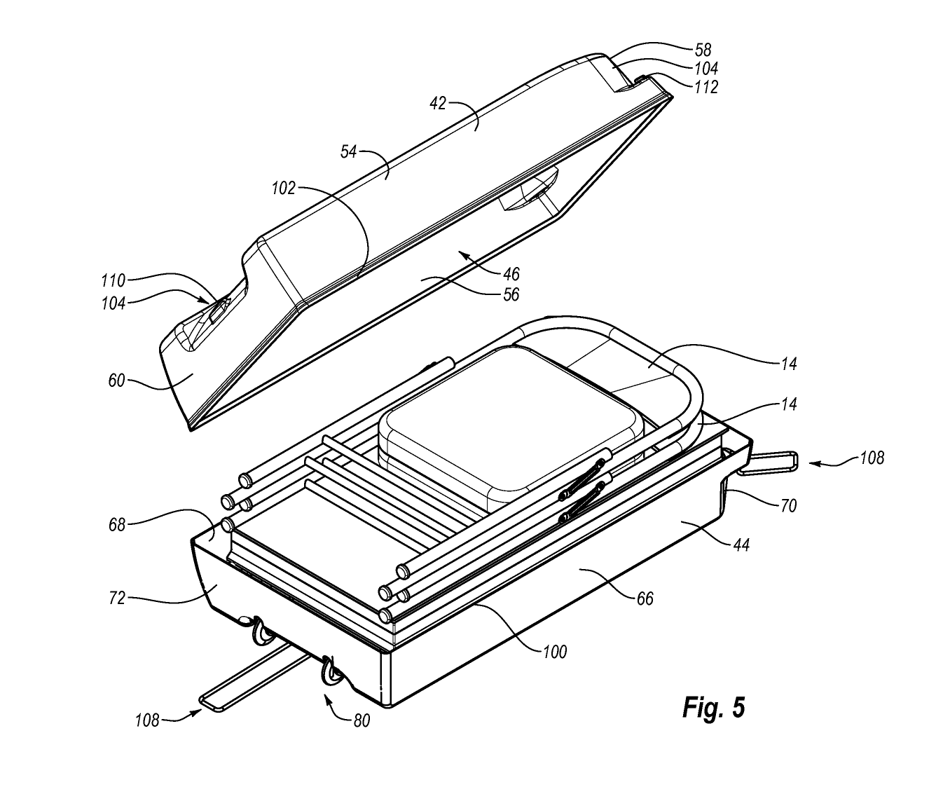

The depth of the interior portion 46 of the first portion 42 of the case 40 may be determined at least in part by the surface 52, the side walls 54, 56, and the end walls 58, 60. Similarly, the depth of the interior portion 48 of the second portion 44 of the case 40 may be determined at least in part by the surface 64, the side walls 66, 68, and the end walls 70, 72. As shown in FIG. 5, the interior portion 48 of the second portion 44 of the case 40 may be deep enough such that the side walls 66, 68 and end walls 70, 72 extend around at least two of the chairs 14 and approximately one-half of the folded table 12. The first portion 42 of the case 40 may be positioned around the upper two chairs 12 and the other half of the table 12. It will be appreciated that the case 40 may have other suitable shapes, sizes, configurations and arrangements depending, for example, upon the shape and size of the table 12 and/or chairs 14. For example, the case 40 may have one or more shapes, sizes, features, aspects and the like as shown in Assignee's pending U.S. patent application Ser. No. ______, filed Jan. 9, 2012 (attorney docket no. L1006.10115US02), which is incorporated by reference in its entirety.

As shown in FIGS. 4 and 5, the first and second portions 42, 44 of the case 40 are illustrated as being movable relative to each other. In particular, the first and second portions 42, 44 of the case 40 may be completely detached or separated. In other embodiments, the first and second portions 42, 44 of the case 40 may be at least partially secured together. For instance, one or more hinges or other connectors may maintain at least one side or part of the first portion 42 of the case 40 in a generally constant position relative to the second portion 44 of the container. Additionally, the first and second portions 42, 44 of the case 40 may have different shapes, sizes, configurations and arrangements. For instance, the first portion 42 of the case 40 may have an interior portion 46 with a depth that is sized and configured to receive a majority, substantially all or all of the table 12 and chairs 14. The second portion 44 could, in such case, be a lid or cover that can be slideably, rotationally or otherwise mounted and/or secured to the first portion 42 of the container. Similarly, the second portion 44 of the case 40 may have an interior portion 48 with a depth that is sized and configured to receive a majority, substantially all or all of the table 12 and chairs 14. Therefore, the first portion 42 could be a lid or cover to the case 40. It will be understood that the first and second portions 42, 44 of the container may have any appropriate depth depending, for example, upon the intended use of the table and chair set 10.

The case 40 can allow efficient, easy and convenient transport and storage of the table 12 and chairs 14. The case 40 may also include one or more mechanisms or structures to facilitate transportation and/or storage. For instance, as best seen in FIGS. 5, 6 and 8, the case 40 can include a wheel assembly 80. The wheel assembly 80 may be at least partially disposed within a wheel assembly receiving portion 82 formed in the second portion 44 of the case 40. The wheel assembly receiving portion 82 is preferably located towards an end of the case 40 and may include a first wheel receiving portion 84 and a second wheel receiving portion 86 that are sized and configured to receive a portion of a first wheel 88 and a second wheel 90, respectively. The wheels 88, 90 may be connected to one or more axles 92 and the ends of the axle may be disposed within openings, apertures or receiving portions, brackets and the like to allow the wheels to rotate relative to the case 40.

In greater detail, the wheel assembly receiving portion 82 may be formed in the lower surface 64 and end wall 72 of the lower portion 44 of the case 40. In addition, if the wheel assembly receiving portion 82 extends inwardly into the interior portion 48 of the lower portion 44 of the case 40, it is preferably sized and configured to allow the legs 18 of the chairs 14 to be disposed around the wheel assembly receiving portion. That is, on one side, the legs 18 of the chairs 14 may be disposed between the side wall 66 and the wheel assembly receiving portion 82 and, on the other side, the legs of the chairs may be disposed between the side wall 68 and the wheel assembly receiving portion. Thus, a first chair leg receiving portion may be disposed between the side wall 66 and the wheel assembly receiving portion 82, and a second chair leg receiving portion may be disposed between the side wall 68 and the wheel assembly receiving portion. Advantageously, this may help align and/or position the chairs 14 and/or table 12 within the case 40. In addition, this may help prevent the chairs 14 and/or table 12 from inadvertently sliding or moving within the case 40.

The wheel assembly 80 may also have other suitable shapes, sizes, arrangements and configurations depending, for example, upon the intended use of the table and chair set 10. For example, the wheels 88, 90 and/or axle 92 may be mounted on one or more bearings, bushings, journaled connections, and the like, or operate in another manner that allows the wheels 88, 90 to rotate so as to facilitate movement of the case 40 and/or table and chair set 10. Optionally, the wheels 88, 90 may extend into the interior 48 of the lower portion 44 of the case 40. In some embodiments, the extent to which the wheels 88, 90 extend into the interior 48 of the lower portion 44 of the case 40 may be less than or equal to the depth of two chairs 14 in the folded and stacked configuration. In such a configuration, two chairs 14 may be stacked within the lower portion 44 of the case 40 such that the legs 18 are positioned adjacent the wheels 88, 90. The legs 18 may be size, configured and spaced apart such that the chairs 14 do not interfere with the rotation of the wheels 88, 90. Positioning the wheels 88, 90 in such manner can also reduce the overall size of the case 40 and/or allow the size of wheels to be increased, which may provide better stability and/or ease of movement of the case and/or the table and chair set 10.

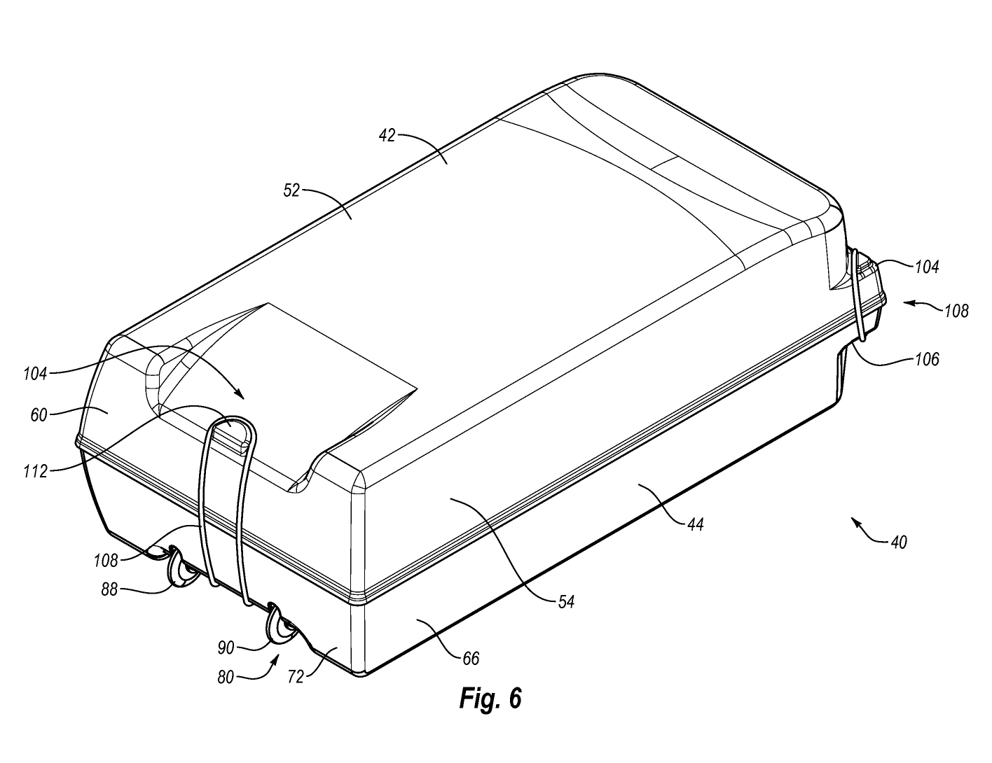

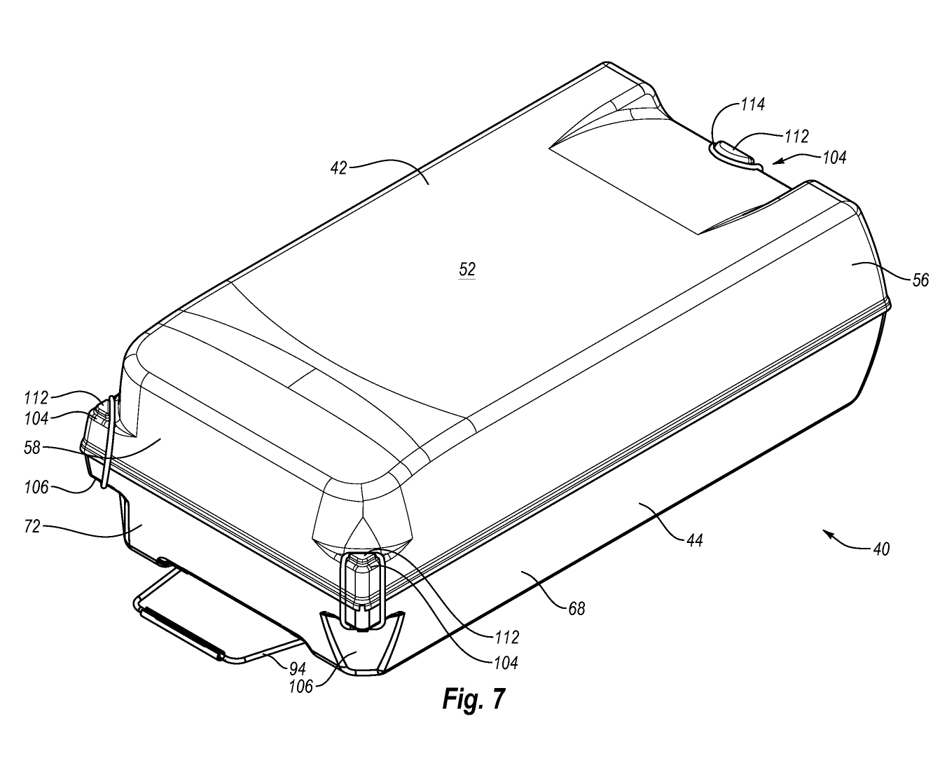

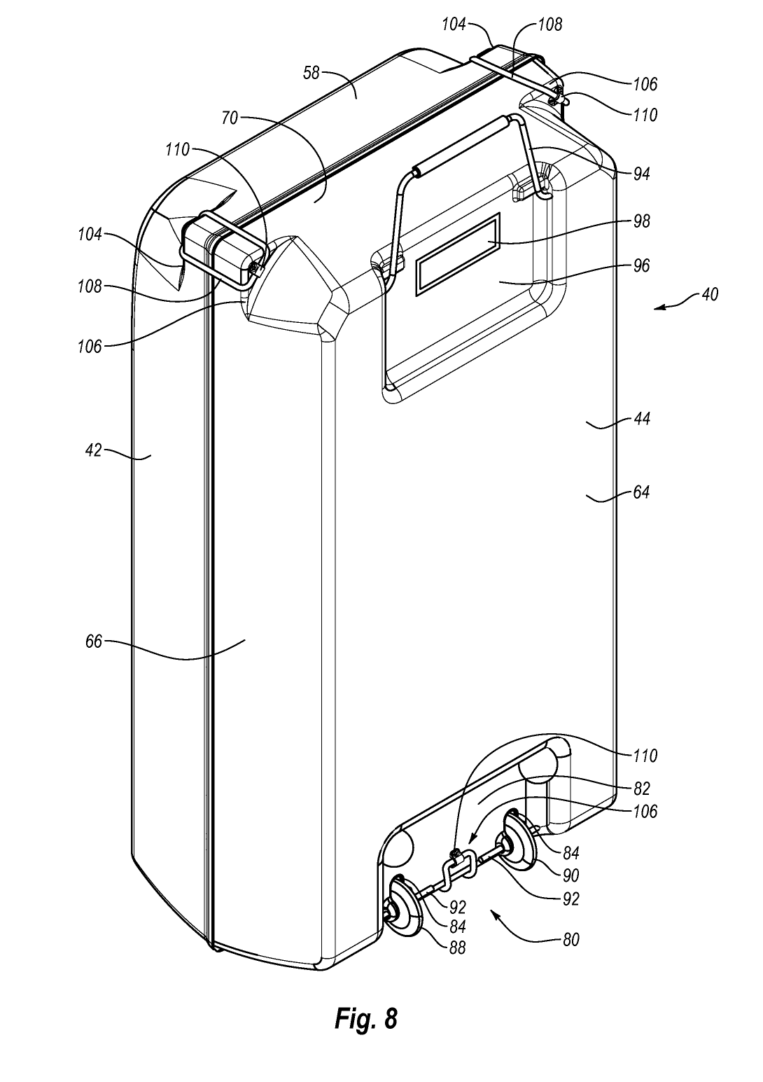

The wheels 88, 90 may be positioned to allow the case 40 to stand in an upright configuration as shown in FIG. 8. In addition, the wheels 88, 90 may be positioned to allow the case 40 to be disposed in a horizontal configuration as shown in FIGS. 6 and 7. Thus, the wheels 88, 90 may not extend beyond a plane aligned with the lower surface 64 and/or the end wall 72 of the case 40. In this embodiment, multiple cases 40 may be stacked and aligned, which may facilitate shipping by the manufacturer, displaying and storing by the retailer, and use by the consumer.

The wheel assembly 80 may allow the case 40 to be wheeled from one location to another. Thus, during a single trip, a person can transport the table and chair set 10 which may include one or more tables 12, chairs 14 and the cases 40. Accordingly, a six piece set (one table 12, four chairs 14 and the case 40) can be efficiently moved and transported by an individual. Furthermore, the case 40 can have a size that is relatively easy to store. For example, as noted above, the table 10 may have a size of about three feet by about eighteen inches in the folded position. The chairs 14 may also have a size of about three feet by about eighteen inches in the folded position. Therefore, when the folded table 12 and chairs 14 are stacked or aligned, the outer perimeter of the table and chairs may be generally aligned. In addition, the table 12 and chairs 14 may fit tightly and securely within the interior of the case 40. Thus, the interior of the case 40 may have dimensions slightly larger than the outer perimeter of the folded table 12 and chairs 14. For example, if the folded table 12 and chairs 14 have an outer perimeter of about three feet by about eighteen inches, then the interior of the case 40 may have dimensions slightly larger than about three feet by about eighteen inches. Further, the case 40 may have outer dimensions only slightly larger than about three feet by about eighteen inches. For example, if the case 40 is constructed from blow-molded plastic and includes only a single wall between the interior and exterior surfaces of the container, the container may have dimensions only slightly larger than the outer periphery of the folded table 12 and chairs 14.

The case 40 may have a depth or thickness that is slightly larger than the depth or thickness of the folded, stacked table 12 and chairs 14. For example, the table 12 in the folded configuration may have a thickness between about three and about four inches. The chairs 14 in the folded configuration may have thickness between about three and about five inches, such as about four inches. Therefore, if the table and chair set 10 includes one table 12 and four chairs 14, then the depth or thickness of the stacked components may be between about fifteen and twenty-four inches. The case 40 preferably has a depth of thickness that corresponds to the depth or thickness of the folded, stacked table 12 and chairs 14 in order to minimize the depth or thickness of the case.

As illustrated in FIGS. 7 and 8, the case 40 may have an optional handle 94. In greater detail, the second or lower portion 44 of the case may include a handle receiving portion 96 that is disposed away or towards an opposite end from the wheel assembly 80. The handle receiving portion 96 may be primarily formed in the lower surface 64 and the end wall 70 of the lower portion 44 of the case 40 and it may be generally inwardly disposed to facilitate stacking and/or shipping of the case. As shown in the accompanying figures, the handle 94 in this embodiment may be a separately formed component mounted to the lower portion 44 of the case 40. The handle 94 may be pivotally attached to the case 40 and movable between an extended or use position and a collapsed position in which all or a portion of the handle may be disposed in the handle receiving portion 96. Thus, when the handle 94 is in the collapsed position, it may facilitate storage of the case 40.

Because the handle receiving portion 96 may extend inwardly into the interior of the lower portion 44 of the case 40, it may be sized and configured to facilitate positioning of the table 12 and/or chairs 14 within the container. For example, the handle receiving portion 96 may be sized and configured to receive or be disposed within an upper portion of the chairs 14, such as the backrest 36. This may allow the handle receiving portion 96 to help align the chairs 14 and/or table 12 within the case 40, and may help prevent the chairs and/or table from sliding or moving within the case. As best seen in FIG. 8, the depth of the handle receiving portion 96 may be less than the wheel assembly receiving portion 82. In addition, the handle receiving portion 96 and the wheel assembly receiving portion 82 may be generally aligned with the side walls of the handle receiving portion disposed parallel and/or aligned with the side walls of the wheel assembly receiving portion.

When the handle 94 is in the extended or use position, as shown in FIGS. 7 and 8, the handle may be gripped to allow a user to pull the case 40 and thereby move the tables 12 and/or chairs 14 located within the case. Optionally, the handle 94 may be removable. In still other embodiments, the handle 94 can be moved by sliding, rotating, and the like between one or more positions. For instance, the handle 94 may be rotated to position the handle within the handle receiving portion 96 formed in the lower portion 44 of the case 40. The handle 94 may in some embodiments be biased into a desired position using a spring or other mechanism. In particular, the biasing mechanism may facilitate retention of the handle 94 in the retracted and/or extended positions. Using such a mechanism, a force that exceeds that of the biasing force may be required to transition the handle 94 from one position to another position.

The case 40 may also include a gripping ridge 98 that may be integrally formed during the manufacturing process as part of a unitary, one-piece structure. The gripping ridge 98 may be used to facilitate handling and movement of the case 40. For example, the handle 94 and/or the gripping ridge 98 may be used to move and position the case 40.

As also illustrated in FIGS. 5 and 6, the case 40 may be sized and configured to facilitate mating of the first and second portions 42, 44. For instance, the second portion 44 may contain an upper lip, edge or ridge 100 that is sized and configured to mate or contact a lower lip, edge or engaging surface 102 of the first portion 42 of the case 40. The edge 100 and engaging surface 102 may allow a tight fit and secure connection between the upper and lower portions 42, 44 of the case 40. In greater detail, the engaging surface 102 may form part of a groove, recess or receiving portion that is sized and configured to receive the edge 100. This may create, for example, a tongue and groove connection between the upper and lower portions 42, 44 of the case 40. Specifically, the edge 100 may abut the engaging surface 102 and/or the edge may sit within the groove or receiving portion to facilitate positioning and connection the first and second portions 42, 44 of the case 40.

The case 40 may be selectively locked or maintained in a closed position. For instance, one or more latches may be used to maintain the case 40 in the closed position. Alternatively, one or more mechanisms or structures may be used to secure the first and second portions 42, 44 of the case 40 together. It will be appreciated that the case 40 may be secured in various suitable manners.

In an exemplary embodiment, the first and second portions 42, 44 of the case 40 may include upper and lower attachment portions 104, 106, respectively. For example, the upper portion 42 of the case 40 may include two attachment portions 104 and the lower portion 44 of the case may include two corresponding attachment portions 106. A connector, such as a locking pin, clamp, clasp, or other mechanism, can be used to selectively secure the case 40 in the closed position. The connector could also be a latch that is connected to the lower attachment portion 106 and sized and configured to be selectively attached to the upper attachment portion 104.

As shown in FIGS. 5-8, an exemplary embodiment of the case 40 may include three connectors that are used to secure the upper and lower portions 42, 44 in the closed position. The connectors may comprise a resilient or elastic cord or line 108 that is attached to a portion of the case 40, such as the lower attachment portions 106. In particular, the ends or a portion of the line 108 may be connected to the lower attachment portions 106 by a bracket 110. The line 108 may then be looped or otherwise disposed around at least a portion of the upper attachment portions 104. For instance, the upper attachment portions 104 may include an outwardly extending protrusion 112 and a receiving portion 114, such as a groove, notch or recess, and the line 108 may be disposed about the protrusion and in the receiving portion. Advantageously, the elastic line 108 may be stretched around the protrusion 112 and placed in the receiving portion 114. Because the line 108 may be elastic, it may easily, quickly and securely connect the upper and lower portions 42, 44 of the case 40.

As shown in the accompanying figures, the end of the case 40 including the handle 94 may include a corresponding pair of upper and lower attachment portions 104, 106. The upper and lower attachment portions 104, 106 may have generally similar shapes, sizes, configurations and arrangements. In particular, the upper and lower attachment portions 104, 106 may be disposed in the corners of the case 40 proximate the handle 94. The lower attachment portions 106 may include a generally planar surface in which the line 108 is attached and the upper attachment portion 104 may include a generally planar surface in which the protrusion 112 is located. The upper and lower attachment portions 104, 106 are preferably disposed in a recess, cutout or inwardly extending portion of the corners.

The end of the case 40 including the wheel assembly 80, however, may include only a single connector and it may include a line 108 that is longer than the line of the other connectors. The line 108 may be attached to the lower attachment portion 106 by the bracket 110 and it may be looped around the protrusion 112 and disposed in the receiving portion 1114 of the upper attachment portion 104. Preferably, the lines 108 are resilient to secure the case 40 in the closed position. It will be appreciated that any suitable number and type of connectors may be used to secure the case 40 in the closed position.

The upper and lower attachment portions 104, 106, protrusions 112 and receiving portions 114 may be integrally formed with the case 40 as part of a unitary, one-piece structure. In particular, if the case 40 is constructed from blow-molded plastic, then the upper and lower attachment portions 104, 106, protrusions 112 and receiving portions 114 may be integrally formed as part of a unitary, one-piece structure during the blow-molding process. In addition, other aspects, features and components may be integrally formed with the case 40 as part of a unitary, one-piece structure. For example, the wheel assembly receiving portion 82, handle receiving portion 96, upper and lower attachment portions 104, 106, protrusions 112 and/or receiving portions 114 may be integrally formed with the case 40 as part of a unitary, one-piece structure during the blow-molding process. Advantageously, this may simplify and expedite the manufacturing process.

If the case 40 is constructed from blow-molded plastic, a single outer wall may form the upper and lower portions 42, 44 of the case. In particular, the entire case 40 may be blow-molded at one time and the outer wall of the blow-molded plastic structure may form both the upper and lower portions 42, 44 of the case. Significantly, this may allow the entire case 40 to be formed at once and the outer wall may only have a single layer, which may decrease the weight and amount of material required to construct the case. Further, if the case 40 is formed with a single outer wall, the dimensions of the case may be decreased and that may facilitate shipping and storage of the case.

The case 40 may be cut along its length and/or width to create an opening. For example, as shown in the attached figures, the case 40 may be cut along its circumference to form the upper and lower portions 42, 44. If the case 40 is constructed from blow-molded plastic and includes a single outer wall, it may be relatively easy to cut.

During the manufacturing process, the case 40 may be constructed from blow-molded plastic and various features may be integrally formed as part of a unitary, one-piece structure. The case 40 may then be cut to create an opening into which the tables 12 and chairs 14 may be loaded and unloaded. The case 40 may be secured in the closed position by looping the lines 108 around the protrusions 112 and into the receiving portions 114. The manufacturer may then ship and/or transport the case 40 to retailers or consumers.

In operation, the case 40 may be opened by removing the upper portion 42 from the lower portion 44. Two folded chairs 14 may be placed in the interior 48 of the lower portion 44 with the legs 18 disposed in the chair leg receiving portions located between the side walls 66, 68 of the case 40 and the wheel assembly receiving portion 82. A folded table 12 may then be placed on the folded chairs 14 and two more folded chairs may be stacked on top of the table. The folded table 12 and chairs 14 preferably have the same general footprint such that the perimeter of the stacked table and chairs is generally aligned. In addition, the stacked table 12 and chairs 14 may be sandwiched together. The upper portion 42 may then be used to close the case 40. The lines 108 may be looped around the protrusions 112 and into the receiving portions 114 to secure the case 40 in the closed position. In greater detail, an inner surface of the lower portion 44, two lower chairs 14, table 12, two upper chairs and an inner surface of the upper portion 42 of the container may be aligned, stacked, in contact, and sandwiched together. The wheels 88, 90, handle 94, and/or gripping edge 98 may be used to move the container into the desired location.

When it is desired to use the table and chair set 10, the case 40 may be opened by removing the lines 108 from the receiving portions 114 and removing the upper portion 42. The table 12 and chair 14 may then be taken out of the case 40. The table 12 and chairs 14 may be stored or returned to the container in the manner described above. Advantageously, the table and chair set 10 may be easy to use, lightweight and readily portable.

It will be appreciated that the table and chair set 10, and its various components such as the table 12, chairs 14 and case 40, may have a variety of suitable shapes, sizes, configurations and arrangements depending, for example, upon the intended use of the table and/or chairs. It will also be appreciated that the devices, apparatus, kits, components and the like disclosed herein may be formed or made in any suitable manner, and can be made of any number of different materials. For instance, the tables, chairs and/or containers of the table and chair set 10 may be formed from one or more materials such as metals, composites, polymers, organic materials and the like. In greater detail, in accordance with an exemplary embodiment, the table 12 may include components constructed from metal, such as the frame and/or legs, and other components constructed from other materials, such as a plastic or polymeric table top. In addition, various components of the table and chair set 10 may be constructed from different processes such as the table top 16 may be formed from blow-molded plastic because, for example, it allows a strong, lightweight, rigid and sturdy table top to be quickly and easily manufactured. Other conventional molding processes, such as rotational molding and injection molding, can also be used. Advantageously, a blow-molded plastic table top may be lighter weight that conventional table tops constructed from wood or metal, although the table top may be formed of metals or wood. The chairs 14 may be similarly constructed. For instance, the seat 34 and/or the backrest 36 may be formed from blow-mold plastic because, for example, it allows a strong, lightweight, rigid and sturdy part to be quickly and efficiently manufactured. Metal and/or wood chairs may, also be used. Chairs 14 may also include, in some embodiments, fabric or other elements.

The case 40 may be constructed such that it is substantially rigid but, in other embodiments, all or a portion of the container may be flexible. For instance, the case 40 may be constructed from blow-molded plastic because blow-molded plastic is relatively durable, weather resistant, temperature insensitive, corrosion resistant, rust resistant, and blow-molded plastic generally does not deteriorate over time. One skilled in the art will appreciate that the case 40 does not have to be constructed from blow-molded plastic and other suitable materials and/or processes can be used, such as other types of plastics, polymers, synthetic materials, natural materials, or any other material or combination thereof. In addition, the case 40 may be constructed from other materials with sufficient strength and desirable characteristics such as plywood, particle board, solid wood, wood slates, metal alloys, fiberglass, ceramics, graphite, and the like. Portions of a table 12 and/or chairs 14 may similarly be constructed.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A table and chair set comprising:
a folding table including a first table top section and a second table top section movable between a folded position and an unfolded position, the folding table top having a footprint in the folded position;
a folding chair movable between a folded position and an unfolded position, the folding chair having a footprint in the folded position generally equal or slightly smaller than the footprint of the folding table in the folded position; and
a case comprising:
a first portion including a cavity sized and configured to receive at least a portion of the folding table and the folding chair in the folded positions, the cavity having a size generally equal to or slightly larger than the footprint of the folding table and the folding chair in the folded positions to allow an outer perimeter of the footprint of the folding table and folding chair to be disposed at least proximate an interior of the cavity; and
a second portion including a cavity sized and configured to receive at least a portion of the folding table and folding chair in the folded positions, the cavity having a size generally equal to or slightly larger than the footprint of the folding table and the folding chair in the folded positions to allow the outer perimeter of the footprint of the folding table and folding chair to be disposed at least proximate an interior of the cavity.

2. The table and chair set as in claim 1, wherein the case is constructed from blow-molded plastic;
wherein a single outer wall of the blow-molded plastic structure forms the first portion of the case and the second portion of the case; and
wherein the cavity of the first portion of the case and the cavity of the second portion of the case are defined by the single outer wall of the blow-molded plastic structure.

3. The table and chair set as in claim 1, further comprising four folding chairs, each of the folding chairs having a height and a width in the folded position that is generally equal to a height and a width of the table top in the folded position.

4. The table and chair set as in claim 3, wherein the cavity of the first portion of the case and the cavity of the second portion of the case are sized and configured to receive the folding table and the four folding chairs in the folded positions.

5. The table and chair set as in claim 3, wherein the footprint of the folding table and the folding chair in the folded positions is generally equal to or slightly less than about thirty-six inches by about eighteen inches; and
wherein the cavity of the first portion of the case and the cavity of the second portion of the case have interior dimensions generally equal to or slightly larger than about thirty-six inches by about eighteen inches.

6. The table and chair set as in claim 1, further comprising:
a wheel assembly receiving portion integrally formed in the second portion of the case as part of a unitary, one-piece structure;
a first chair leg receiving portion disposed between a first side wall of the second portion of the case and the wheel assembly receiving portion; and
a second chair leg receiving portion disposed between a second side wall of the second portion of the case and the wheel assembly receiving portion.

7. The table and chair set as in claim 1, further comprising:
a first wheel receiving portion integrally formed in the second portion of the case as part of a unitary, one-piece structure;
a second wheel receiving portion integrally formed in the second portion of the case as part of the unitary, one-piece structure;
a first wheel disposed in the first wheel receiving portion; and
a second wheel disposed in the second wheel receiving portion;
wherein when the folding chair is disposed in the second portion of the case, a first chair leg is disposed between a first side wall of the second portion of the case and the first wheel and a second chair leg is disposed between a second side wall of the second portion of the case and the second wheel.

8. The table and chair set as in claim 1, further comprising a handle receiving portion and a wheel assembly receiving portion integrally formed with the case as part of a unitary, one-piece structure, a first sidewall of the handle receiving portion and a first side wall of the wheel assembly receiving portion being generally aligned in parallel planes, and a second sidewall of the handle receiving portion and a second side wall of the wheel assembly receiving portion being generally aligned in parallel planes.

9. The table and chair set as in claim 1, further comprising four folding chairs, each of the folding chairs having a height and a width in the folded position that is generally equal to a height and a width of the table top in the folded position;
wherein the four folding chairs and the folding table are aligned in a stacked configuration within the cavity of the first portion of the case and the cavity of the second portion of the case when the folding chairs and the folding table are disposed inside the case in the folded positions.

10. The table and chair set as in claim 9, wherein a first chair contacts an inner surface of the cavity of the first portion of the case;
wherein a second chair, the table and a third chair are stacked and aligned with the first chair;
wherein a fourth chair contacts an inner surface of the cavity of the second portion of the case;
wherein the four chairs and table are disposed in stacked configuration with the footprint of the chairs generally aligned with the footprint of the table; and
wherein the inner surface of the cavity of the first portion of the case, the four folding chairs, the folding table and the inner surface of the cavity of the second portion of the case are sandwiched together when the chairs and the table are disposed within the case.

11. A table and chair set comprising:
at least one folding table including a table top movable between a folded position and an unfolded position;
at least four folding chairs, each chair movable between a folded position and an unfolded position; and
a storage case constructed from blow-molded plastic, the storage case comprising:
a single wall forming an outer perimeter of the storage case, an outer surface of the single wall forming an outer surface of the case; and
an interior cavity sized and configured to receive the at least one folding table in the folded position and the at least four folding chairs in the folded position, an inner surface of the single wall forming the interior cavity;
wherein the single wall and the interior cavity of the case are integrally formed during the blow-molding process as part of a unitary, one-piece construction.

12. The table and chair set as in claim 11, wherein the folding table has a footprint in the folded position;
wherein the folding chair has a footprint in the folded position substantially equal to the footprint of the folding table in the folded position; and
wherein the interior cavity of the storage case has an inner perimeter corresponding to a size of the footprint of the folding table and the footprint of the folding chair to allow an outer perimeter of the folding table and an outer perimeter of the folding chair to be disposed at least proximate the inner perimeter of the storage case.

13. The table and chair set as in claim 11, further comprising:
a first wheel receiving portion integrally formed in the storage case as part of a unitary, one-piece structure;
a second wheel receiving portion integrally formed in the storage case as part of the unitary, one-piece structure;
a first wheel disposed in the first wheel receiving portion; and
a second wheel disposed in the second wheel receiving portion;
wherein when a folding chair is disposed in the storage case, a first chair leg is disposed between a first side wall of the storage case and the first wheel and a second chair leg is disposed between a second side wall of the storage case and the second wheel.

14. The table and chair set as in claim 11, wherein each of the folding chairs has a height and a width in the folded position that is generally equal to a height and a width of the table top in the folded position;
wherein the folding chairs and the table are aligned in a stacked configuration within the interior cavity of the storage case.

15. The table and chair set as in claim 11, further comprising:
a wheel assembly receiving portion integrally formed in the single outer wall of the storage case, the wheel assembly receiving portion allowing at least one wheel to be attached the storage case;
a handle receiving portion integrally formed in the single outer wall of the storage case, the handle receiving portion including a handle to facilitate movement of the storage case; and
at least one attachment portion integrally formed in the single outer wall of the storage case, the attachment portion allowing the storage case to be secured in a closed position;
wherein the wheel assembly receiving portion, the handle receiving portion, the at least one attachment portion and the case are part of a unitary, one-piece structure that are integrally formed during the blow-molding process.

16. A method of manufacturing a case for a table and chair set, the method comprising:
blow-molding a storage case from a single blow-molded plastic wall, an outer portion of the single wall forming an outer perimeter of the storage case and an inner portion of the single wall forming an interior cavity, the interior cavity being sized and configured to receive a table with a folding table top in a folded position and four chairs in a folded position; and
cutting the storage case to form a first receiving portion and a second receiving portion;
wherein the first receiving portion and the second receiving portion are sized and configured to allow the table and the chairs to be inserted and removed from the storage case.

17. The method as recited in claim 16, wherein the table top in the folded position has a footprint that is substantially equal to a footprint of the chairs in the folded position; and
wherein the interior cavity of the storage case has inner dimensions substantially equal to the footprint of the table top in the folded position and the footprint of the chairs in the folded position.

18. The method as recited in claim 16, wherein the storage case is sized and configured to allow two of the four chairs to be placed within the storage case prior to placing the table within the storage case.

19. The method as recited in claim 16, further comprising:
integrally forming a first wheel receiving portion in the storage case as part of the unitary, one-piece structure;
integrally forming a second wheel receiving portion in the storage case as part of the unitary, one-piece structure;
disposing a first wheel in the first wheel receiving portion; and
disposing a second wheel in the second wheel receiving portion;
wherein when a chair is disposed in the storage case, a first chair leg is disposed between a first side wall of the storage case and the first wheel and a second chair leg is disposed between a second side wall of the storage case and the second wheel.

20. The method as recited in claim 16, further comprising:
integrally forming a wheel assembly receiving portion in the single wall of the storage case, the wheel assembly receiving portion allowing at least one wheel to be attached the storage case;
integrally forming a handle receiving portion in the single wall of the storage case, the handle receiving portion including a handle to facilitate movement of the storage case; and
integrally forming at least one attachment portion in the single outer wall of the storage case, the attachment portion allowing the first receiving portion and the second receiving portion of the storage case to be secured in a closed position;
wherein the wheel assembly receiving portion, the handle receiving portion, the at least one attachment portion and the case are part of a unitary, one-piece structure that are integrally formed during the blow-molding process.
